(19) United States
(12) Patent Application Publication
(10) Pub. No.: US 2008/0102227 A1
(43) Pub. Date: May 1, 2008

(54) Liquid crystal display

(75) Inventor: Woo-Jin Bae, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/895,902

(22) Filed: Aug. 28, 2007

(30) Foreign Application Priority Data
Nov. 1, 2006 (KR) 10-2006-0107081

(51) Int. Cl. G02F 1/1337

(52) U.S. Cl. 428/1.2

(57) ABSTRACT

A liquid crystal display is provided, which includes first and second substrates, a liquid crystal layer formed between the first and second substrates, an alignment layer formed on at least one of the first and second substrates, and a blocking layer formed between at least one of the first and second substrates and the alignment layer and including a water soluble conductive polymer and a clay.

### CROSS-REFERENCE TO RELATED APPLICATION

This application claims priority to and the benefit of Korean Patent Application No. 10-2006-0107081 filed in the Korean Intellectual Property Office on Nov. 1, 2006, the entire contents of which are incorporated herein by reference.

### BACKGROUND OF THE INVENTION

(a) Field of the Invention

The present invention relates to a liquid crystal display.

(b) Description of the Related Art

A liquid crystal display (LCD) is one of the most widely used flat panel displays. An LCD includes two panels provided with field-generating electrodes such as pixel electrodes and a common electrode, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

In the LCD, the electric fields are generated between the pixel electrodes and the common electrode, such that the electric fields determine the orientations of LC molecules in the LC layer. Accordingly, the changes of orientations of liquid crystal molecules generate the change of the transmittance of the LCD, so the LCD displays images according to the change of the transmittance. The electric fields generated between the pixel electrodes and the common electrode are regulated by the voltage of the pixel electrodes, which are controlled by thin film transistor switching elements. The thin film transistors transmit or block a voltage transmitted to data lines according to scanning signals transmitted to gate lines.

Alignment layers that align the liquid crystal molecules of the liquid crystal layer in predetermined directions are formed on facing surfaces of the two panels of the LCD. The alignment of the liquid crystal display is strongly influenced by the alignment anchoring force of the surface of the alignment layers.

However, if an alignment layer is damaged by static electricity from the outside or by impurities of a gas or ion impurities generated from the organic layer of the panels, this damage appears as spots and negatively influences the alignment of the liquid crystal layer.

### SUMMARY OF THE INVENTION

Embodiments are provided for minimizing surface damage to an alignment layer to prevent the generation of spots and improve the alignment quality of the liquid crystal.

A liquid crystal display is provided, which includes first and second substrates, a liquid crystal layer formed between the first and second substrates, an alignment layer formed on at least one of the first and second substrates, and a blocking layer formed between at least one of the first and second substrates and the alignment layer and including a water soluble conductive polymer and a clay.

The water soluble conductive polymer and the clay may form a nanocomposite.

The water soluble conductive polymer may include a self-doped water soluble polypyrrole graft copolymer.

The self-doped water soluble polypyrrole graft copolymer may be represented as the following Chemical Formula (I):

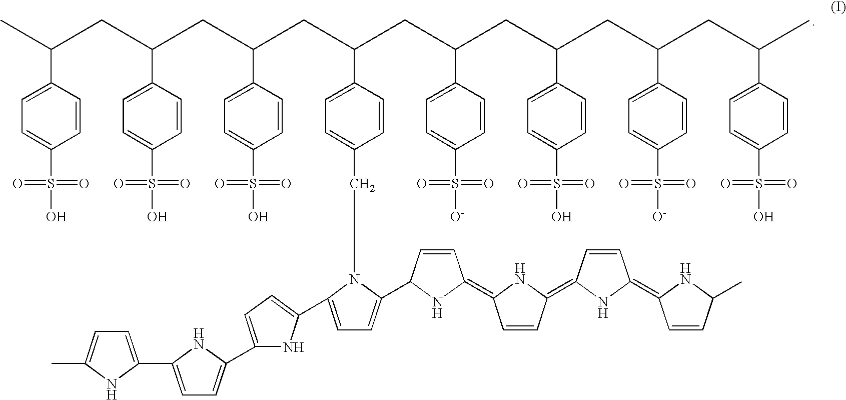

It is preferable that the number of polypyrroles in the copolymer is in the range of 2 to 400.

The blocking layer may further include a silane coupling agent.

The alignment layer may be anti-water-soluble.

The liquid crystal display may further include gate and data lines formed on the first substrate and crossing each other, a thin film transistor connected to the gate and data lines, and a pixel electrode connected to the thin film transistor.

The pixel electrode may include a cutout.

### BRIEF DESCRIPTION OF THE DRAWINGS

The present invention will become more apparent by describing embodiments thereof in detail with reference to the accompanying drawings, in which:

FIG. 1 is a layout view of a TFT array panel of an LCD according to an embodiment of the present disclosure;

FIG. 2 is a layout view of a common electrode panel of an LCD according to an embodiment of the present disclosure;

FIG. 3 is a layout view of an LCD including the TFT array panel shown in FIG. 1 and the common electrode panel shown in FIG. 2;

FIG. 4 is a cross-sectional view of the LCD shown in FIG. 3 taken along the line IV-IV;

FIG. 5 is a cross-sectional view of the LCD shown in FIG. 3 taken along the line V-V;

FIG. 6 is an enlarged view of the portion “A” in FIG. 4.

### DETAILED DESCRIPTION OF EMBODIMENTS

The present invention will be described more fully hereinafter with reference to the accompanying drawings, in which preferred embodiments of the invention are shown. The present disclosure may, however, be embodied in many different forms and should not be construed as limited to the embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Now, liquid crystal displays according to embodiments of the present disclosure will be described with reference to the accompanying drawings.

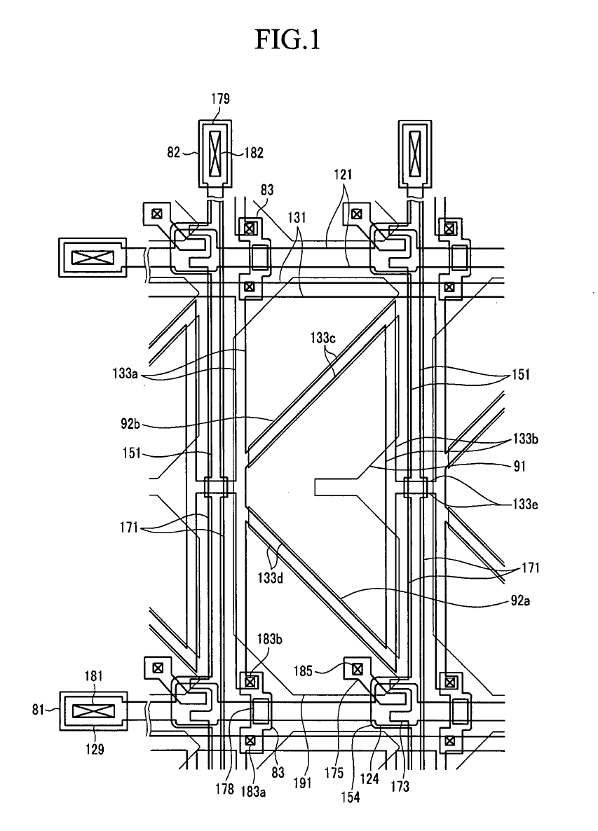

An LCD according to an embodiment of the present disclosure will be described in detail with reference to FIGS. 1 to 5.

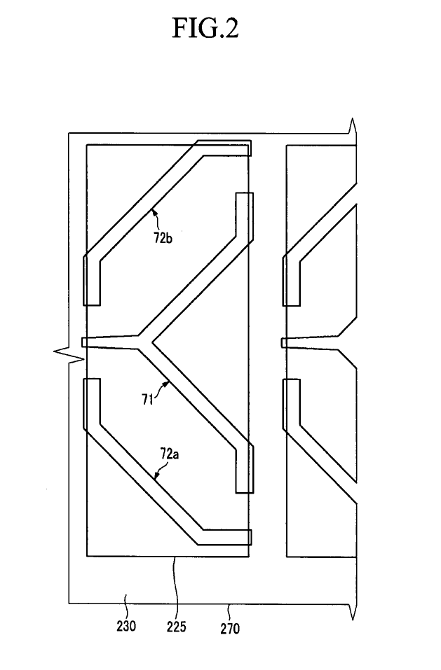

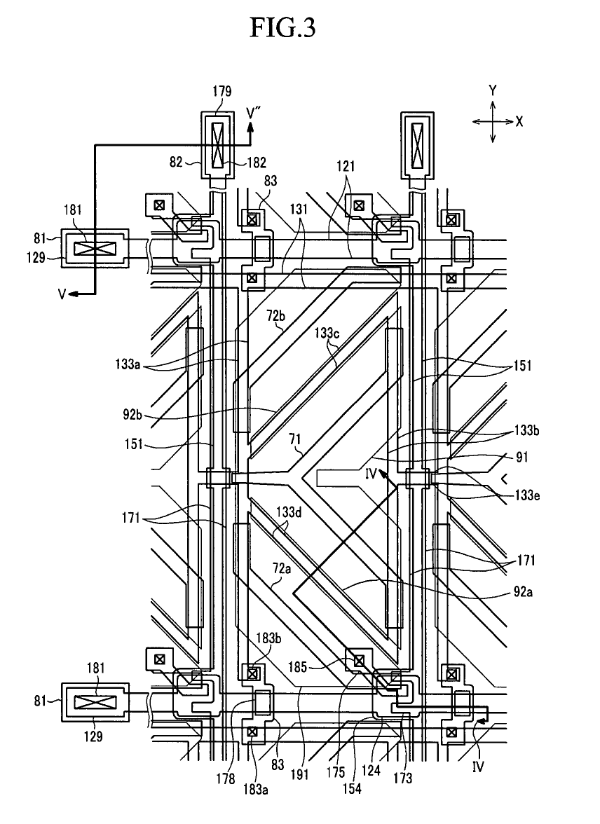

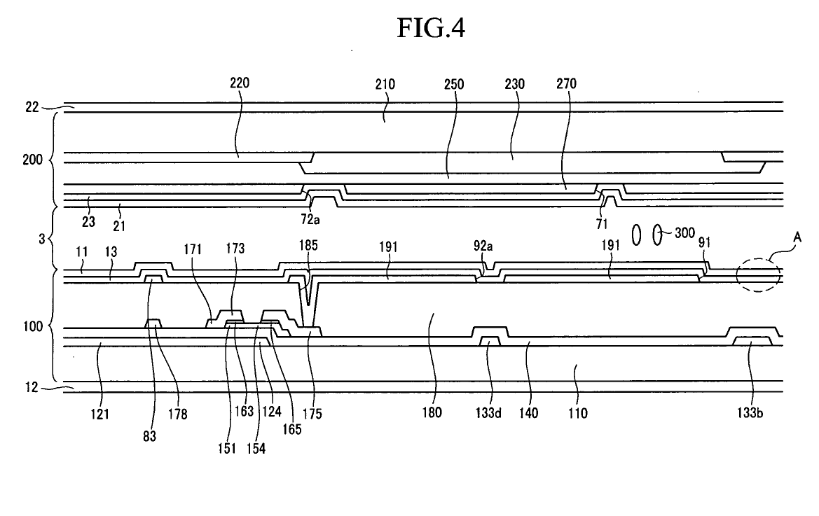

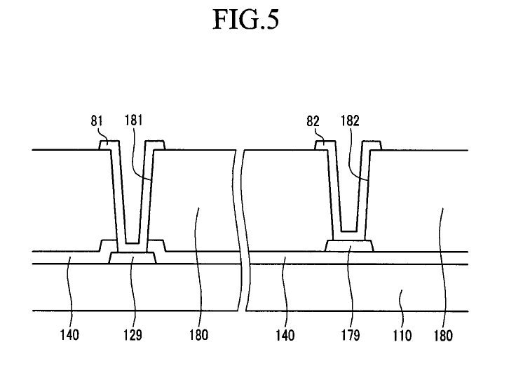

FIG. 1 is a layout view of a TFT array panel of an LCD according to an embodiment of the present disclosure, FIG. 2 is a layout view of a common electrode panel of an LCD according to an embodiment of the present disclosure, FIG. 3 is a layout view of an LCD including the TFT array panel shown in FIG. 1 and the common electrode panel shown in FIG. 2, FIG. 4 is a cross-sectional view of the LCD shown in FIG. 3 taken along the line IV-IV, and FIG. 5 is a cross-sectional view of the LCD shown in FIG. 3 taken along the line V-V″.

Referring to FIG. 4, an LCD according to one embodiment includes a TFT array panel 100, a common electrode panel 200, and an LC layer 3 interposed between the panels 100 and 200.

The TFT array panel 100 is now described in detail with reference to FIGS. 1, 3, 4, and 5.

A plurality of gate lines 121 and a plurality of storage electrode lines 131 are formed on an insulating substrate 110 made of a material such as transparent glass.

The gate lines 121 extend substantially in a transverse direction and are separated from each other and transmit gate signals. Each gate line 121 includes a plurality of projections forming a plurality of gate electrodes 124 and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated with the substrate 110. The gate lines 121 may extend to be connected to a driving circuit that may be integrated with the substrate 110.

The storage electrode lines 131 are supplied with a predetermined voltage. Each of the storage electrode lines 131 extends substantially in the transverse direction and is disposed between two adjacent gate lines 121, and is closer to an upper one of the two gate lines 121. Each storage electrode line 131 includes a plurality of sets of branches 133a to 133d and a plurality of connections 133e connecting the branches 133a to 133d.

A set of branches 133a to 133d includes two longitudinal branches forming first and second storage electrodes 133a and 133b that are spaced apart from each other, and two oblique branches forming third and fourth storage electrodes 133c and 133d that are connected between the first and second storage electrodes 133a and 133b. In detail, the first storage electrode 133a has a free end portion and a fixed end portion that is connected to the storage electrode line 131, and has a projection. The third and fourth storage electrodes 133c and 133d extend approximately from a center of the first storage electrode 133a to upper and lower ends of the second storage electrode 133b, respectively. However, the storage electrode lines 131 may have various shapes and arrangements.

Each of the connections 133e is connected between a first storage electrode 133a of a set of storage electrodes 133a to 133d and a second storage electrode 133b of another set of storage electrodes 133a to 133d adjacent thereto.

The gate lines 121 and the storage electrode lines 131 are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti, and Ta. The gate lines 121 and the storage electrode lines 131 may have a multi-layered structure including two films having different physical characteristics.

In addition, the lateral sides of the gate lines 121 and the storage electrode lines 131 are inclined relative to a surface of the substrate, and the inclination angle thereof is in a range from about 30 to 80 degrees.

A gate insulating layer 140 preferably made of silicon nitride (SiNx) or silicon oxide (SiOx) is formed on the gate lines 121 and the storage electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. The semiconductor stripes 151 become wide near the gate lines 121 and the storage electrode lines 131 such that the semiconductor stripes 151 cover large areas of the gate lines 121 and the storage electrode lines 131.

A plurality of ohmic contact stripes and islands 161 and 165 preferably made of silicide or n+ hydrogenated a-Si heavily doped with an n-type impurity such as phosphorous are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are inclined relative to a surface of the substrate, and the inclination angles thereof are preferably in a range from about 30 to 80 degrees.

A plurality of data lines 171, a plurality of drain electrodes 175 separated from the data lines 171, and a plurality of isolated metal pieces 178 are formed on the ohmic contacts 161 and 165 and the gate insulating layer 140.

The data lines 171 for transmitting data voltages extend substantially in the longitudinal direction and cross the gate lines 121 at right angles. The data lines 171 also intersect the storage electrode lines 131 and the connections 133e such that each data line 171 is disposed between the first and second storage electrodes 133a and 133b in adjacent sets of the branches 133a to 133d of the storage electrode lines 131. Each data line 171 includes an end portion 179 having a large area for contact with another layer or an external device. A data driving circuit (not shown) for generating the data signals may be mounted on an FPC film (not shown), which may be attached to the substrate 110, directly mounted on the substrate 110, or integrated with the substrate 110. The data lines 171 may extend to be connected to a driving circuit that may be integrated with the substrate 110. Each data line 171 includes a plurality of source electrodes 173 projecting toward the drain electrodes 175.

Each drain electrode 175 includes an end portion having a large area for contact with another layer, and another end portion disposed on a gate electrode 124 and partly surrounded by a source electrode 173.

A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The metal pieces 178 are disposed on the gate lines 121 near the end portions of the storage electrodes 133a.

The data lines 171, the drain electrodes 175, and the metal pieces 178 are preferably made of a refractory metal such as Cr, Mo, Ti, Ta, and alloys thereof. However, they may also have a multi-layered structure including a low-resistivity film (not shown) and a refractory metal film (not shown).

Like the gate lines 121 and the storage electrode lines 131, the data lines 171 and the drain electrodes 175 have tapered lateral sides, and the inclination angles thereof are in a range from about 30 to 80 degrees.

The ohmic contacts 163 and 165 are interposed only between the underlying semiconductor stripes 151 and the overlying data lines 171 and the overlying drain electrodes 175 thereon, and reduce the contact resistance therebetween. The semiconductor stripes 151 include a plurality of exposed portions, which are not covered with the data lines 171 and the drain electrodes 175, such as portions located between the source electrodes 173 and the drain electrodes 175. Although the semiconductor stripes 151 are narrower than the data lines 171 at most places, the width of the semiconductor stripes 151 becomes large near the gate lines 121 and the storage electrode lines 131 as described above, to smooth the profile of the surface, thereby preventing the loss of continuity of the data lines 171. The semiconductor stripes 151 include some exposed portions, which are not covered with the data conductors 171 and 175, such as portions located between the source electrodes 173 and the drain electrodes 175.

A passivation layer 180 is formed on the data lines 171, the drain electrodes 175, the metal pieces 178, and the exposed portions of the semiconductor stripes 151. The passivation layer 180 is preferably made of an organic material having a good flatness characteristic. The passivation layer 180 may include a lower film of an inorganic insulator and an upper film of an organic insulator such that it takes the excellent insulating characteristics of the organic insulator while preventing the exposed portions of the semiconductor stripes 151 from being damaged by the organic insulator.

A plurality of pixel electrodes 191, a plurality of contact assistants 81 and 82, and a plurality of overpasses 83, which are preferably made of a transparent conductor such as indium tin oxide (ITO) or indium zinc oxide (IZO) or a reflective conductor such as Ag or Al, are formed on the passivation layer 180.

The pixel electrodes 191 are physically and electrically connected to the drain electrodes 175 through the contact holes 185 such that the pixel electrodes 191 receive the data voltages from the drain electrodes 175.

The pixel electrodes 191 supplied with the data voltages generate electric fields in cooperation with a common electrode 270, which determine the orientations of liquid crystal molecules in the liquid crystal layer 3.

A pixel electrode 191 and the common electrode 270 of the common electrode panel 200 form a liquid crystal capacitor, which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping the pixel electrodes 191 with the storage electrode lines 131 including the storage electrodes 133a to 133d.

Each pixel electrode 191 is chamfered at its left corners, and the chamfered edges of the pixel electrode 191 make an angle of about 45 degrees with the gate lines 121.

Each pixel electrode 191 has a lower cutout 92a, a center cutout 91, and an upper cutout 92b, which partition the pixel electrode 191 into a plurality of partitions. The cutouts 91 to 92b substantially have inversion symmetry with respect to an imaginary transverse line bisecting the pixel electrode 191.

The lower and upper cutouts 92a and 92b obliquely extend from a right edge of the pixel electrode 191 near an upper right corner approximately to a center of a left edge of the pixel electrode 191, and overlap the third and fourth storage electrodes 133c and 133d. The lower and upper cutouts 92a and 92b are disposed at lower and upper halves of the pixel electrode 191, respectively, which can be divided by the imaginary transverse line. The lower and upper cutouts 92a and 92b make an angle of about 45 degrees with the gate lines 121, and they extend substantially perpendicular to each other.

The center cutout 91 extends along the imaginary transverse line and has an inlet from the right edge of the pixel electrode 191, which has a pair of inclined edges substantially parallel to the lower cutout 92a and the upper cutout 92b, respectively.

Accordingly, the lower half of the pixel electrode 191 is partitioned into two lower partitions by the lower cutout 92a and the upper half of the pixel electrode 191 is partitioned into two upper partitions by the upper cutout 92b. The number of partitions or the number of cutouts is varied depending on design factors such as the size of pixels, the ratio of the transverse edges and the longitudinal edges of the pixel electrodes, the type and characteristics of the liquid crystal layer 3, and so on.

The overpasses 83 cross over the gate lines 121 and are connected to the exposed projection of the fixed end portions of the first storage electrodes 133a and the exposed portions of the storage electrode lines 131 through contact holes 183b and 183a, respectively, which are disposed opposite each other with respect to the gate lines 121. The overpasses 83 overlaps the metal pieces 178, and they may be electrically connected to the metal pieces 178. The storage electrode lines 131 including the storage electrodes 133a to 133d along with the overpasses 83 and the metal pieces 178 may be used for repairing defects in the gate lines 121, the data lines 171, or the TFTs.

The contact assistants 81 and 82 are connected to the end portions 129 of the gate lines 121 and the end portions 179 of the data lines 171 through contact holes 181 and 182, respectively. The contact assistants 81 and 82 protect the end portions 129 and 179 and complement the adhesion of the end portions 129 and 179 and external devices.

A description of the common electrode panel 200 follows with reference to FIGS. 2 to 4.

A light blocking member 220 called a black matrix for preventing light leakage is formed on an insulating substrate 210 made of a material such as transparent glass. The light blocking member 220 may include a plurality of openings 225 that face the pixel electrodes 191 and may have substantially the same planar shape as the pixel electrodes 191. Otherwise, the light blocking member 220 may include linear portions corresponding to the data lines 171 and the gate lines 121, and other portions corresponding to the TFTs.

A plurality of color filters 230 are formed on the substrate 210, and they are disposed substantially in the areas enclosed by the light blocking member 220. The color filters 230 may extend substantially along the longitudinal direction along the pixel electrodes 191. The color filters 230 may represent one of the primary colors such as red, green, and blue colors.

An overcoat 250 for preventing the color filters 230 from being exposed and for providing a flat surface is formed on the color filters 230 and the light blocking member 220. The overcoat 250 may be omitted.

The common electrode 270 that is preferably made of a transparent conductive material such as ITO and IZO is formed on the overcoat 250, and is thicker than the pixel electrode 191.

The common electrode 270 has a plurality of sets of cutouts 71 to 72b.

A set of cutouts 71 to 72b faces a pixel electrode 191, and includes a lower cutout 72a, a center cutout 71, and an upper cutout 72b. Each of the cutouts 71 to 72b is disposed between adjacent cutouts 91 to 92b of the pixel electrode 191 or between a cutout 92a or 92b and a chamfered edge of the pixel electrode 191. In addition, each of the cutouts 71 to 72b has at least an oblique portion extending parallel to the lower cutout 92a or the upper cutout 92b of the pixel electrode 191, and the distances between two adjacent cutouts 71 to 72b and 91 to 92b, the oblique portions thereof, the oblique edges thereof, and the chamfered edges of the pixel electrode 191, which are parallel to each other, are substantially the same. The cutouts 71 to 72b have substantially mirror symmetry with respect to the above-described transverse line bisecting the pixel electrode 191, and are wider than the cutouts 91 to 92b of the pixel electrode 191.

Each of the lower and upper cutouts 72a and 72b includes an oblique portion extending approximately from a left edge of the pixel electrode 191 to approximately a lower or upper edge of the pixel electrode 191, and transverse and longitudinal portions extending from respective ends of the oblique portion along edges of the pixel electrode 191, overlapping the edges of the pixel electrode 191, and making obtuse angles with the oblique portion.

The center cutout 71 includes a central transverse portion extending approximately from the left edge of the pixel electrode 191 along the third storage electrode 133c, a pair of oblique portions extending from an end of the central transverse portion approximately to a right edge of the pixel electrode and making obtuse angles with the central transverse portion, and a pair of terminal longitudinal portions extending from the ends of the respective oblique portions along the right edge of the pixel electrode 191, overlapping the right edge of the pixel electrode 191, and making obtuse angles with the respective oblique portions.

The number of the cutouts 71 to 72b may be varied depending on design factors, and the light blocking member 220 may also overlap the cutouts 71 to 72b to block the light leakage through the cutouts 71 to 72b.

Upon application of the common voltage to the common electrode 270 and a data voltage to the pixel electrodes 191, an electric field substantially perpendicular to the surfaces of the panels 100 and 200 is generated. The LC molecules tend to change their orientations in response to the electric field such that their long axes become perpendicular to the field direction. The common electrode 270 and the pixel electrodes 191 are used as field-generating electrodes.

The cutouts 91 to 92b and 71 to 72b of the electrodes 191 and 270 and the edges of the pixel electrodes 191 distort the electric field to have a horizontal component that is substantially perpendicular to the edges of the cutouts 91 to 92b and 71 to 72b and the edges of the pixel electrodes 191. Accordingly, the LC molecules on each sub-area are tilted in a direction by the horizontal component and the azimuthal distribution of the tilt directions are localized to four directions, thereby increasing the viewing angle of the LCD.

The number and the arrangements of the cutouts 71 to 72b and 91 to 92b may be varied depending on design factors.

At least one of the cutouts 91 to 92b and 71 to 72b can be substituted with protrusions (not shown) or depressions (not shown). The protrusions are preferably made of an organic or inorganic material and disposed on or under the field-generating electrodes 191 or 270.

Blocking layers 13 and 23 are formed on inner surfaces of the panels 100 and 200. The blocking layers 13 and 23 may be formed of a nanocomposite including a conductive polymer and a clay, and will be described in detail later.

Alignment layers 11 and 21 that may be homeotropic are coated on inner surfaces of the blocking layers 13 and 23. The alignment layers 13 and 23 may be made of a water insoluble material such as polyimide.

Polarizers 12 and 22 are provided on outer surfaces of the panels 100 and 200 such that their polarization axes may be crossed and one of the transmissive axes may be parallel to the gate lines 121. One of the polarizers may be omitted when the LCD is a reflective LCD. The structure of the polarizers 12 and 22 will be described in detail later.

The LCD may further include at least one retardation film (not shown) for compensating the retardation of the LC layer 3. The retardation film has birefringence and retards opposite to the LC layer 3.

The LCD may further include a backlight unit (not shown) for supplying light to the LC layer 3 through the polarizers 12 and 22, the retardation film, and the panels 100 and 200.

It may be preferable that the LC layer 3 has negative dielectric anisotropy and is subjected to vertical alignment such that the LC molecules 300 in the LC layer 3 are aligned with their long axes substantially vertical to the surfaces of the panels 100 and 200 in the absence of an electric field. Accordingly, incident light cannot pass the crossed polarization system of the polarizers 12 and 22.

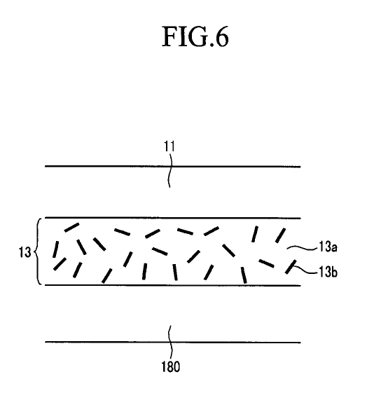

Next, a description of the blocking layers 13 and 23 follows with reference to FIGS. 6 and 4.

FIG. 6 is an enlarged view of the portion “A” of FIG. 4.

The blocking layers 13 and 23 comprise a plurality of nanocomposites including a conductive polymer 13a and a clay 13b.

The conductive polymer 13a includes a self-doped water soluble polypyrrole graft copolymer represented as in Chemical Formula (I):

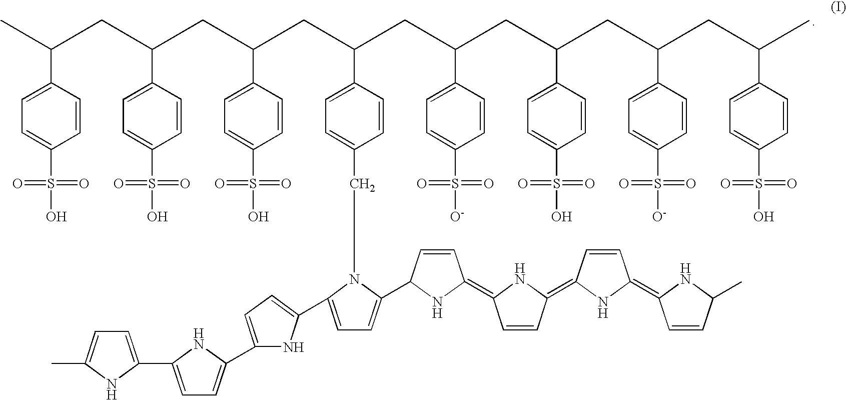

It may be preferable that the number of polypyrroles in Chemical Formula (I) is in the range of 2 to 400, and more particularly 4 to 32. If the number of polypyrroles is less than 2, the self-doped water soluble polypyrrole graft copolymer has a conductive property. When the number of polypyrroles is greater than 400, it is difficult for the self-doped water soluble polypyrrole graft copolymer to be polymerized.

The polypyrrole graft copolymer may formed by grafting a pyrrol monomer to a main chain of polystyrene sulfonate.

Because the main chain has a function as a dopant, it is not necessary for the copolymers to include an additional dopant to improve solubility, and because the copolymer may be easily melted in an aqueous solution.

Accordingly, the phase separation between the polypyrrole and the dopant may be prevented. The phase separation may be generated when adding the additional dopant to the polypyrrole to easily melt the polypyrrole into the solvent. Also, because the polypyrrole is easily melted into the solvent, the polypyrrole has good chemical attraction with the clay such that the nanocomposites may be completely exfoliated.

The clay has a layered silicate structure, and may be made of a compound including at least one of the following materials: montmorillonite, hectorite, saponite, fluorohectorite, and laponite. The size of the layered unit particles is in the range of nanometers.

The clay may be an exfoliation platy clay having a large aspect ratio with a length of about 100 to 1000 nm and a thickness of about 1 nm as a primary unit, and about 5 to 10 pieces of the exfoliation platy clay are combined with a weak van der Waals force and become one particle. This particle is dispersed in the polypyrrole graft copolymer solution, and the nanocomposites have different structures according to the size of the clay and the degree of the dispersion.

The nanocomposites of the polypyrrole graft copolymer and the clay are manufactured with an aqueous solution, and may be formed in a thin film by using a solution process such as spin coating. Here, the nanocomposite solution may include a small quantity of a silane coupling agent such as methyltrimethoxysilane or tetraethyl orthosilicate (TEOS) to become water insoluble, and the thin film may be easily cleaned by using water after the formation of the thin film. The content of the silane coupling agent may be in the range of about 0.1 to 2 wt % in the total content of the nanocomposite solution.

This thin film may block the gas and the impurities by the platy structure of the clay, and the static electricity from the outside may be easily discharged by the low resistivity of the polypyrrole graft copolymer.

In the embodiment according to the present invention, the blocking layers 13 and 23 made of the nanocomposites are formed under the alignment layers 11 and 21, such that the blocking layers 13 and 23 prevent the gas and the impurities generated from the passivation layer 180 or/and the overcoat 250 from moving to the alignment layers. Accordingly, the generation of spots in the display may be minimized. Also, the blocking layers 13 and 23 rapidly remove the static electricity from the outside such that the blocking layers 13 and 23 prevent the charges of the static electricity from moving to the alignment layers 11 and 21. Accordingly, the static electricity spots and the alignment inferiority of the liquid crystal molecules may be prevented.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display comprising:
first and second substrates;
a liquid crystal layer formed between the first and second substrates;
an alignment layer formed on at least one of the first and second substrates; and
a blocking layer formed between at least one of the first and second substrates and the alignment layer and including a water soluble conductive polymer and a clay.

2. The liquid crystal display of claim 1, wherein the water soluble conductive polymer and the clay form a nanocomposite.

3. The liquid crystal display of claim 1, wherein the water soluble conductive polymer includes a self-doped water soluble polypyrrole graft copolymer.

4. The liquid crystal display of claim 3, wherein the self-doped water soluble polypyrrole graft copolymer is represented by the following Chemical Formula (I):

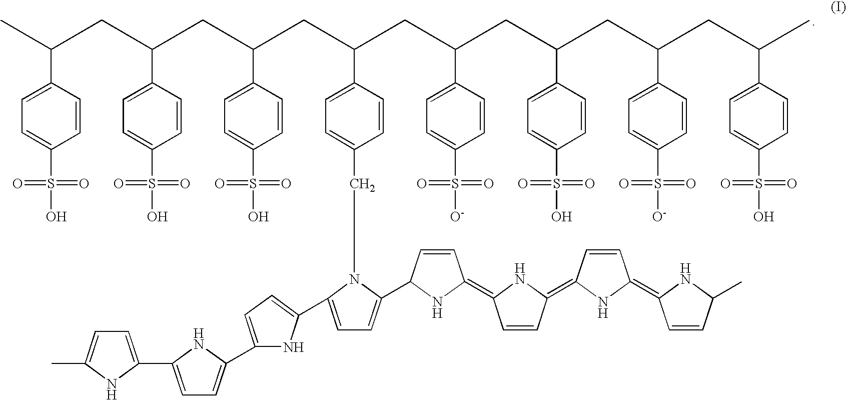

5. The liquid crystal display of claim 1, wherein the number of polypyrroles in the copolymer is in a range of 2 to 400.

6. The liquid crystal display of claim 1, wherein the blocking layer further includes a silane coupling agent.

7. The liquid crystal display of claim 1, wherein the alignment layer is water insoluble.

8. The liquid crystal display of claim 1, further comprising:
a plurality of gate lines and data lines formed on the first substrate and crossing each other;
a plurality of thin film transistors respectively connected to gate and data lines; and
a pixel electrode connected to each of the thin film transistors.

9. The liquid crystal display of claim 8, wherein the pixel electrodes include a cutout.
